(19) United States
(12) Patent Application Publication
(10) Pub. No.: US 2014/0268325 A1
(43) Pub. Date: Sep. 18, 2014

(54) PATTERNED RETARDER FILM

(71) Applicant: BENQ MATERIALS CORPORATION, Taoyuan County (TW)

(72) Inventor: Fung-Hsu WU, Taoyuan County (TW)

(73) Assignee: BENQ MATERIALS CORPORATION, TAOYUAN COUNTY (TW)

(21) Appl. No.: 13/846,204

(22) Filed: Mar. 18, 2013

(51) Int. Cl. G02B 27/22

(52) U.S. Cl. CPC G02B 27/22
USPC 359/463

(57) ABSTRACT

Disclosed herein is a patterned retarder film for 3D display. The patterned retarder film includes a substrate, a patterned retarder layer and a micro-louver structure. The patterned retarder layer on the surface of the substrate has a plurality of first retardation micro structures and a plurality of second retardation micro structures and can split the image into two phase of images to form stereo image; the micro-louver structure is disposed between the substrate and the patterned retarder layer at the boundary of the first retardation micro structures and the second retardation micro structures. The micro-louver structure can decrease the crosstalk of the 3D display at vertical viewing angle and does not decrease the brightness of the 3D display at normal viewing angle.

### BACKGROUND

1. Field of the Invention

The invention relates to a patterned retarder film for 3D display, and more particularly to a patterned retarder film with a micro-louver structure. The patterned retarder film can reduce crosstalk effect when watching 3D display at vertical viewing angle, and does not decrease the brightness when watching 3D display at central viewing angle.

2. Description of the Related Art

The stereo image of current film-typed patterned retarder (FPR) 3D display is constituted by two groups of image data of different viewing angles, wherein one group of image data is corresponding to the left eye viewing angle, and the other one is corresponding to the right eye viewing angle. Viewers can watch the stereo image by using a pair of specific polarized glasses which is designed to see individual image data.

Referring to FIG. 1, the patterned retarder film 400 with crossed-stripes pattern can split pixels of panel into odd line L1, L2 and L3 for left eye and even line R1, R2 and R3 for right eye to form the two groups of image data of different viewing angles.

The two groups of image data of different viewing angles of the patterned retarder film 400 are interleaved with each other and arranged in the horizontal direction. Therefore, if the position of viewer changes vertically or the viewers are at different vertical angles, there will be crosstalk between the two groups of image data of different viewing angles, and the crosstalk will affect the comfort of viewer and decrease the quality of the stereo image. Currently, it is suggested as shown in FIG. 2, to enlarge the width of the black matrix (BM) between the pixels corresponding to the two groups of image data with dyeing resin, metal or combination thereof for reducing the crosstalk. However, this method will decrease the brightness of the 3D display when the viewer watches the 3D display at central viewing angle, and need to increase the brightness of the backlight and power consumption in advance. As a result, there still exists a need to provide a patterned retarder film to improve the above issues.

### BRIEF SUMMARY

In an embodiment of the present invention, a patterned retarder film for 3D display comprises a substrate; a patterned retarder layer on the substrate having a plurality of first retardation micro structures and a plurality of second retardation micro structures, wherein the plurality of first retardation micro structures and the plurality of second retardation micro structures are stripe structures, and the stripe structures are parallel to and interleaved with each other; and a micro-louver structure disposed between the substrate and the patterned retarder layer at the boundary area of the first retardation micro structures and the second retardation micro structures, wherein the micro-louver structure is extending in the direction of the first retardation micro structures and the second retardation micro structures.

In another embodiment of the present invention, the patterned retarder film further comprises a liquid crystal layer on the patterned retarder layer for forming a plurality of the first retardation on the plurality of first retardation micro structures and a plurality of the second retardation on the plurality of second retardation micro structures to split the image of display into two phase of images to form stereo image.

In another embodiment of the present invention, a method for manufacturing the micro-louver structure of the patterned retarder film comprises the steps of forming a plurality of micro-grooves on the substrate with engraving process, and filling dyeing resin, metal or the combination thereof in the plurality of micro-grooves to form the micro-louver structure.

In another embodiment of the present invention, a method for manufacturing the micro-louver structure of the patterned retarder film comprises the steps of laminating a micro-louver structure layer between the substrate and the patterned retarder layer to form the micro-louver structure.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a conventional patterned retarder film with crossed-stripes pattern;

FIG. 2 shows a conventional improving method for crosstalk with enlarging the width of the black matrix;

FIG. 3 shows the situations of crosstalk at different viewing angles;

FIG. 4 shows a cross-sectional view of the patterned retarder film with a micro-louver structure of an embodiment of the present invention;

FIG. 5 shows a top-view of the patterned retarder film with the micro-louver structure of an embodiment of the present invention; and

FIG. 6 shows a cross-sectional view of the patterned retarder film with a micro-louver structure of another embodiment of the present invention.

### DETAILED DESCRIPTION

Please note the drawings shown in the Figures are for illustrative purposes only and not to scale.

Referring to FIG. 4, in an embodiment of the present invention, a patterned retarder film 500 for 3D display comprises a substrate 100; a patterned retarder layer 40 on the substrate 100 having a plurality of first retardation micro structures L and a plurality of second retardation micro structures R, wherein the plurality of first retardation micro structures L and the plurality of second retardation micro structures R are stripe structures, and the stripe structures are parallel to and interleaved with each other; and a micro-louver structure 200 disposed between the substrate 100 and the patterned retarder layer 40 at the boundary of the first retardation micro structures L and the second retardation micro structures R, wherein the micro-louver structure 200 is extending in the direction of the first retardation micro structures L and the second retardation micro structures R.

Please referring to FIG. 3, the prior art patterned retarder film 400 is without the micro-louver structure 200. When the viewer wears specific 3D glasses at the central position B, the backlight 30 passes through a left eye image region 5L and a right eye image region 5R of the panel, and transforms to the stereo image with the plurality of first retardation micro structures L and the plurality of second retardation micro structures R; when the viewer is at the position A of large vertical viewing angle, the viewer will catch the images from the left eye image region 5L and the right eye image region 5R at the same time, and there will be crosstalk to decrease the quality of the stereo image.

The patterned retarder film 500 of an embodiment of the present invention shown as FIG. 4, has the micro-louver structure 200; therefore, when the viewer is at the position A, the direction of the depth D of the micro-louver structure 200 will provide shielding effect, and the eyes will see the individual image without crosstalk; when the viewer is at the position B, the viewer still can catch the stereo image through the spacing S of the micro-louver structure 200. Also referring to FIG. 5, comparing to the prior art patterned retarder film 400 as shown in FIG. 3, the miniaturization of the micro-louver structure 200 do not substantially decrease the transparence of the patterned retarder film 500 at central viewing angle, thereby increasing brightness of the backlight is not necessary.

In an embodiment of the present invention, the width W of the micro-louver structure 200 is in a range of 0.5 μm to 5 μm; the aspect ratio D/W of the micro-louver structure 200 is in a range of 1 to 100; the spacing S of the micro-louver structure 200 is in a range of 0.5 μm to 5 μm. The pixel size of 3D display is usually in a range of 200 μm to 600 μm, and the width of black matrix is in a range of 80 μm to 200 μm for reducing crosstalk. Because the width W of the micro-louver structure 200 is much smaller than the width of black matrix, the micro-louver structure 200 can reduce crosstalk without decreasing the brightness of backlight.

In another embodiment of the present invention, the patterned retarder film 500 further comprises a liquid crystal layer (not shown) on the patterned retarder layer 40 for forming a plurality of the first retardation on the plurality of first retardation micro structures L and a plurality of the second retardation on the plurality of second retardation micro structures R to split the image of display into two phase of images respectively for left eye and right eye in order to form stereo image.

In another embodiment of the present invention, the substrate 100 of the patterned retarder film 500 is made of a material selected from the group consisting of polycarbonate, poly methyl methacrylate, cycloolefin polymer, triacetate cellulose and a combination thereof.

In another embodiment of the present invention, the patterned retarder layer 40 is made of a material selected from the group consisting of polycarbonate, poly methyl methacrylate, cycloolefin polymer, triacetate cellulose and a combination thereof.

In another embodiment of the present invention, the micro-louver structure 200 is made of a material selected from the group consisting of dyeing resin, metal and a combination thereof for shielding the oblique light from backlight 30.

In another embodiment of the present invention, the difference between the first retardation and the second retardation is λ/2; the first retardation is in a range of −3/4λ to 3/4λ, and the second retardation is in a range of −3/4λ to 3/4λ.

Referring to FIG. 4, in an embodiment of the present invention, a method for manufacturing the micro-louver structure 200 of the patterned retarder film 500 is provided. The present method comprises the steps of forming a plurality of micro-grooves on the substrate 100 with engraving process, and filling dyeing resin, metal or the combination thereof in the plurality of micro-grooves to form the micro-louver structure 200.

Referring to FIG. 6, in another embodiment of the present invention, a method for manufacturing the micro-louver structure 200 of the patterned retarder film 500 is provided. The method comprises the step of laminating a micro-louver structure layer 20 between the substrate 100 and the patterned retarder layer 40 to form the micro-louver structure 200.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A patterned retarder film for 3D display comprising:
a substrate;
a patterned retarder layer on the substrate having a plurality of first retardation micro structures and a plurality of second retardation micro structures, wherein the plurality of first retardation micro structures and the plurality of second retardation micro structures are stripe structures, and the stripe structures are parallel to and interleaved with each other; and
a micro-louver structure disposed between the substrate and the patterned retarder layer at the boundary area of the first retardation micro structures and the second retardation micro structures,
wherein the micro-louver structure is extending in the direction of the first retardation micro structures and the second retardation micro structures.

2. The patterned retarder film according to claim 1, wherein the width of the micro-louver structure is in a range of 0.5 μm to 5 μm.

3. The patterned retarder film according to claim 1, wherein the aspect ratio of the micro-louver structure is in a range of 1 to 100.

4. The patterned retarder film according to claim 1, wherein the spacing of the micro-louver structure is in a range of 0.5 μm to 5 μm.

5. The patterned retarder film according to claim 1, further comprising a liquid crystal layer on the patterned retarder layer for forming a plurality of the first retardation on the plurality of first retardation micro structures and a plurality of the second retardation on the plurality of second retardation micro structures.

6. The patterned retarder film according to claim 1, wherein the substrate is made of a material selected from the group consisting of polycarbonate, poly methyl methacrylate, cycloolefin polymer, triacetate cellulose and a combination thereof.

7. The patterned retarder film according to claim 1, wherein the patterned retarder layer is made of a material selected from the group consisting of polycarbonate, poly methyl methacrylate, cycloolefin polymer, triacetate cellulose and a combination thereof.

8. The patterned retarder film according to claim 1, wherein the micro-louver structure is made of a material selected from the group consisting of dyeing resin, metal and a combination thereof.

9. The patterned retarder film according to claim 5, wherein the difference between the first retardation and the second retardation is λ/2.

10. The patterned retarder film according to claim 5, wherein the first retardation is in a range of −3/4λ to 3/4λ, and the second retardation is in a range of −3/4λ to 3/4λ.
